(19) United States
(12) Patent Application Publication
(10) Pub. No.: US 2020/0342309 A1
(43) Pub. Date: Oct. 29, 2020

(54) SENSOR ARRAY FOR GENERATING NETWORK LEARNING POPULATIONS USING LIMITED SAMPLE SIZES

(71) Applicant: K2Ai, LLC, Oak Park, MI (US)

(72) Inventor: Kevin Richard Kerwin, Birmingham, MI (US)

(21) Appl. No.: 16/395,648

(22) Filed: Apr. 26, 2019

(51) Int. Cl. G06N 3/08

(52) U.S. Cl. CPC G06N 3/08

(57) ABSTRACT

A method for generating a training data set for machine learning includes disposing a first sample component in or about a sensing apparatus. The sensing apparatus includes a plurality of sensors, each sensor being disposed at a unique position and angle relative to the first sample component. The method captures a first sensor output of each sensor, thereby generating a first training data set including a first plurality of sensor outputs. The method then manipulates at least one of the first sample component and an environment within the sensing apparatus, and captures an additional sensor output of each sensor, thereby generating an additional training data set including an additional plurality of sensor outputs. The method then reiterates the step of manipulating the at least one of the first sample component and the environment within the sensing apparatus and capturing the additional sensor output of each sensor. Finally, the method merges each of the sensor outputs in the first training data set and each additional training data set, thereby generating a full machine learning training set.

### TECHNICAL FIELD

The present disclosure relates generally to methods and apparatuses for generating labeled neural network training data sets (e.g. learning populations), and more specifically to a system and method for generating the same from a limited sample size.

### BACKGROUND

Machine learning systems, such as those using neural networks, are trained by providing the neural network with a labeled data set (referred to as a learning population) including multiple files with each file including tags identifying features of the file. In one example a quality control system using a neural network can be trained by providing multiple images and/or sound files of a product being examined with each image or sound file being tagged as “good” or “bad”. Based on the training set, the neural network can determine features and elements of the images or sound files that indicate if the product is good (e.g. passes quality control) or bad (e.g. needs to be scrapped, reviewed, or reworked).

Once trained, the neural network can be fed new images, movies, or sound files of products as they come off a production line, or at any given point in a manufacturing process. The neural network then analyzes the new images, movies, or sound files based on the training and identifies products that are bad for quality control purposes.

In order to provide sufficient training for such a neural network, the learning population should be adequately sized, and include a substantial number of different orientations and conditions of the object being inspected. By way of example, a typical neural network will require a minimum of thousands of distinct images in order to adequately train the neural network. In some cases, however, a limited number of sample products are available to generate the training set prior to installation of the system.

### SUMMARY OF THE INVENTION

An exemplary method for generating a training data set for machine learning includes disposing a first sample component in or about a sensing apparatus, the sensing apparatus including a plurality of sensors, each sensor in the plurality of sensors being disposed at a unique position and angle relative to the first sample component, capturing a first sensor output of each sensor, thereby generating a first training data set including a first plurality of sensor outputs, manipulating at least one of the first sample component and an environment within the sensing apparatus, and capturing an additional sensor output of each sensor, thereby generating an additional training data set including an additional plurality of sensor outputs, reiterating the step of manipulating the at least one of the first sample component and the environment within the sensing apparatus and capturing the additional sensor output of each sensor, thereby generating an additional training data set including an additional plurality of sensor outputs, and merging each of the sensor outputs in the first training data set and each additional training data set, thereby generating a full machine learning training set.

In another example of the above described exemplary method for generating a training data set for machine leaning at least a portion of the plurality of sensors are image sensors, and at least a portion of the first plurality of sensor outputs and a portion of each additional plurality of sensor outputs are one of images or movies.

In another example of any of the above described exemplary methods for generating a training data set for machine leaning each of the sensors in the plurality of sensors is an image sensor, and wherein each of the sensor outputs in the first plurality of sensor outputs and in each additional plurality of sensor outputs are one of images or movies.

In another example of any of the above described exemplary methods for generating a training data set for machine leaning manipulating at least one of the first sample component and the environment within the sensing apparatus comprises changing an orientation of the first sample relative to the sensing apparatus.

In another example of any of the above described exemplary methods for generating a training data set for machine leaning changing the orientation comprises moving at least one of the sensors in the plurality of sensors relative to the first sample.

In another example of any of the above described exemplary methods for generating a training data set for machine leaning changing the orientation comprises at least one of rotating the first sample about an axis by rotating a mount on which the sample is disposed and tilting the first sample by tilting the mount on which the sample is disposed.

In another example of any of the above described exemplary methods for generating a training data set for machine leaning manipulating at least one of the first sample component and the environment within the sensing apparatus comprises adjusting a lighting within the sample apparatus.

In another example of any of the above described exemplary methods for generating a training data set for machine leaning adjusting the lighting comprises at least one of dimming a light, increasing a brightness of the light, pulsing laser lights, adjusting light patterns, altering a color of the light and pulsing the light.

In another example of any of the above described exemplary methods for generating a training data set for machine leaning manipulating at least one of the first sample component and the environment within the sensing apparatus comprises generating an atmospheric obstruction between at least one of the sensors in the plurality of sensors and the first sample.

In another example of any of the above described exemplary methods for generating a training data set for machine leaning the manipulation of the at least one of the first sample component and the environment within the sensing apparatus is configured to simulate an ambient condition of a factory for producing the component.

Another example of any of the above described exemplary methods for generating a training data set for machine leaning further includes reiterating the steps for at least one additional sample beyond the first sample.

In another example of any of the above described exemplary methods for generating a training data set for machine leaning at least a portion of the plurality of sensors are audio sensors, and at least a portion of the first plurality of sensor outputs and a portion of each additional plurality of sensor outputs are sound files.

Another example of any of the above described exemplary methods for generating a training data set for machine leaning further includes tagging each sensor output in the full machine learning set as a good component when the first sample is a good sample, and tagging each sensor output in the full machine learning set as a bad component when the first sample is a bad sample.

In one exemplary embodiment a sensing apparatus includes a mount configured support a part, a plurality of sensors supported about the mount, each sensor being oriented relative to the mount in distinct orientations from each other sensor in the plurality of sensors, and a computerized controller communicatively coupled to each of the sensors in the plurality of sensors, the computerized controller including a database configured to store outputs of the sensors in the plurality of sensors according to a pre-determined sampling rate.

In another example of the above described sensing apparatus the plurality of sensors includes at least two distinct image sensors.

In another example of any of the above described sensing apparatuses the plurality of sensors includes at least one audio sensor.

Another example of any of the above described sensing apparatuses further includes at least one adjustable light source connected to the computerized controller, and wherein the computerized controller includes instructions configured to cause the computerized controller to adjust the at least one adjustable light source to simulate a factory condition.

Another example of any of the above described sensing apparatuses further includes at least one environmental effect inducer configured to induce a desired ambient atmosphere at the mount.

In another example of any of the above described sensing apparatuses the at least one environmental effect inducer includes at least one of a fan, white noise generator, a smoke machine and a fog machine.

In another example of any of the above described sensing apparatuses the computerized controller further includes a graphical user interface configured to cause the sensing apparatus to perform the steps of capturing a first sensor output of each sensor in the plurality of sensors, thereby generating a first training data set including a first plurality of sensor outputs, manipulating at least one of the mount and an environment within the sensing apparatus, and capturing an additional sensor output of each sensor in the plurality of sensors, thereby generating an additional training data set including an additional plurality of sensor outputs, reiterating the step of manipulating the at least one of the mount and the environment within the sensing apparatus and capturing the additional sensor output of each sensor, thereby generating an additional training data set including an additional plurality of sensor outputs, and merging each of the sensor outputs in the first training data set and each additional training data set, thereby generating a full labeled machine learning training set.

These and other features of the present invention can be best understood from the following specification and drawings, the following of which is a brief description.

### BRIEF DESCRIPTION OF THE DRAWINGS

FIG. 1 illustrates a highly schematic example of a sensor apparatus for generating a large neural network training set from a single sample product, or a limited number of sample products.

FIG. 2 schematically illustrates an example rotary mount for the sensor apparatus of FIG. 1.

FIGS. 3A and 3B illustrate an example tilt mount for the sensor apparatus of FIG. 1.

FIG. 4 schematically illustrates an articulated sensor configuration for the sensor apparatus of FIG. 1.

FIG. 5 is a flow chart illustrating a method for using the sensor apparatus of FIG. 1 to generate a neural network training data set from a limited product sample.

FIG. 6 schematically illustrates an alternate configuration of the sensor apparatus of FIG. 1.

### DETAILED DESCRIPTION

When generating quality control systems, or any other neural network based inspection system, the designers are frequently faced with the task of creating an adequate initial neural network training set based on a substantially limited sample size and without access to the actual plant floor in which the inspection system will be implemented. By way of example, the amount of sample products provided to the designer of the inspection system can be ten, five, or as low as a single product, depending on the manufacturing complexity, availability, and the cost of the product.

Once the sample is provided to an inspection system designer, the designer is tasked with generating the thousands of images, sound files, or other sensor readouts that will be utilized to train the neural network from the limited sample. Manually photographing, and tagging of images, can take months or longer, and can be infeasible in some situations.

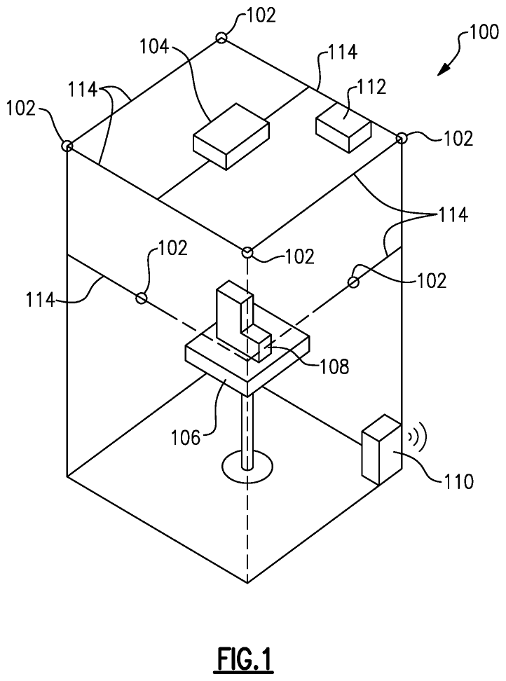

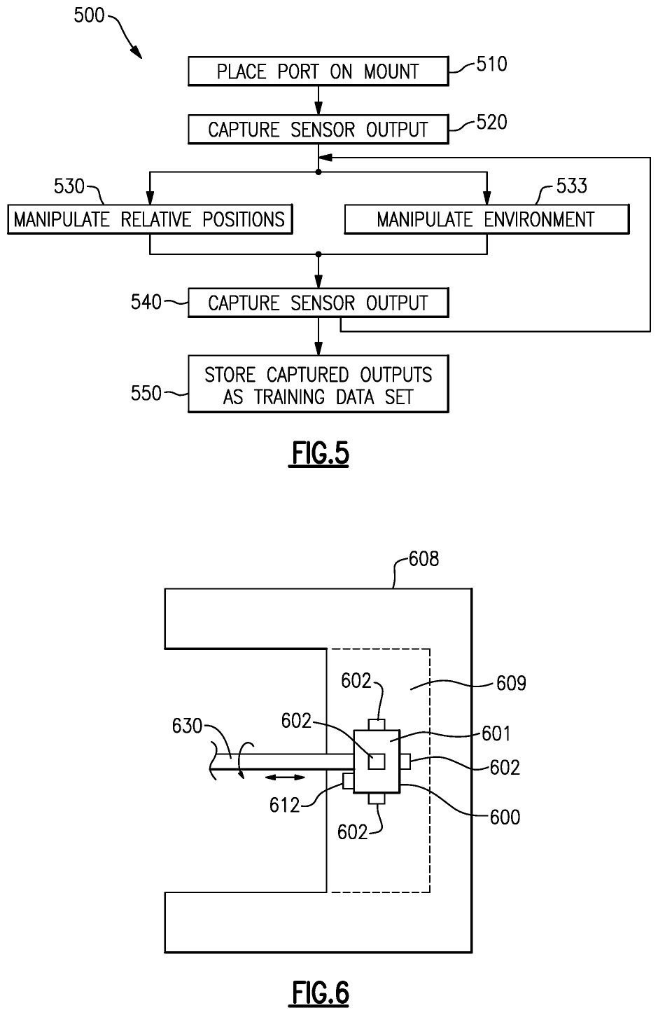

FIG. 1 schematically illustrates a sensing apparatus 100 including multiple sensors 102, such as image/video sensors (cameras) or audio sensors (recording devices). While illustrated in the example of FIG. 1 as including six sensors 102, it is appreciated that any number of sensors 102 can be included at unique angles and dispositions throughout the sensing apparatus 100, and each unique sensor 102 position substantially increases the number of samples that can be obtained from a single part 108. Sensor outputs from a video camera can be chopped to individual frames and provide multiple static images in addition to a video output. The illustrated sensing apparatus 100 is an enclosed booth, with a self-contained and regulated environment. In alternative examples, the sensor apparatus 100 can use a frame supporting the sensors 102 with the internal chamber being exposed to the open air, or can be a pedestal with articulating arms supporting the sensors 102 (e.g. the example of FIG. 4), or any combination of the above. In another example, the sensor apparatus 100 can be a body supporting multiple outward facing sensors and can generate images of an interior of the sample (e.g. the example of FIG. 6).

The sensor apparatus 100 can, in some examples, include a light 104 configured to illuminate a pedestal 106 on which the part 108 generating the learning population is mounted. The light 104 is connected wirelessly with a controller 110, such as a computer. In alternative examples the light 104 can be hard wired to the controller 110. The controller 110 controls the color of the light 104, the brightness of the light 104, and the on/off status of the light 104. During generation of a learning population, the controller 110 utilizes this control to strobe the light, or otherwise adjust the lighting within the sensing apparatus 100 to simulate an environment within a plant, or other facility, where an actual inspection system using the trained neural network will be installed.

In addition to the light 104, an environmental manipulator 112 is included in some example sensing apparatuses 100. The environmental manipulator 112 can include one or more of a smoke machine, a fog machine, laser lights, a fan, and an ambient noise producer. In addition, any other conventional environment altering component could be used here as well. In any example, the environmental manipulator 112 is connected to the controller 110 either wirelessly (as seen in the example of FIG. 1) or hardwired, and the controller 110 is able to control the environmental effects produced by the environmental manipulator 112. By combining the manipulation of the light source 104 and the environmental manipulator 112, the sensing apparatus 100 is able to control the conditions between the part 108 and the sensors 102, thereby simulating the actual conditions of the plant floor in which the inspection system will be installed.

In order to further increase the amount of distinct entries that the training set is able to record off of a single sample part 108, or a limited sample set, the mount 106 on which the part 108 is mounted is configured to be rotated, tilted, or otherwise articulated relative to each of the sensors 102. In some examples, the articulation of the part 108 and mount 106 can be paired with an articulation of one or more of the sensors 102. In the illustrated example of FIG. 1, each of the sensors 102 is positioned on an axis 114 and can be moved about that axis 114 via conventional actuation systems controlled by the controller 110. In further examples, one or more of the axis 114 can be moved about a plane allowing for multiple degrees of movement for a given sensor 102. In another alternative, one or more of the sensors 102 can be mounted to an articulating arm, with the position of the articulating arm being controlled by the controller 110. In yet another example, all of the above described sensor articulation systems can be combined in a single sensing apparatus 100.

With continued reference to FIG. 1, and with like numerals representing like elements, FIG. 2 schematically illustrates an exemplary mount 206 on which the part 108 is mounted. The mount 206 is a platform connected to a rotating actuator 220 by a shaft 222. The actuator 220 can be disposed within the chamber of the sensor apparatus 100, or can be exterior to the chamber, with the shaft 222 protruding into the chamber. In examples incorporating the mount 206 of FIG. 2, the part 108 is articulated relative to the sensors 102 by driving the actuator 220 to rotate. This rotation, in turn, drives a rotation of the shaft 222 and the platform 206 mounted thereon. In some examples, the actuator 220 can include a linear component where rotation of the actuator 220 causes the shaft 222 to shift along the axis of the shaft 222 raising and lowering the platform 206 in addition to, or in place of, the rotation of the platform 206.

As with the lighting system 104 and the environmental manipulator 112, the actuator 220 is connected to, and controlled by, the controller 110. The connection can be wireless (as seen in FIG. 1) or wired. By rotating the platform 206 and/or raising and lowering the platform 206, the position and orientation of the part 108 relative to the sensors 102 is adjusted, allowing for each of the sensors 102 to take multiple unique readings of the part 108, further increasing the number of unique data entries for the learning population that can be automatically obtained from a single sample 108.

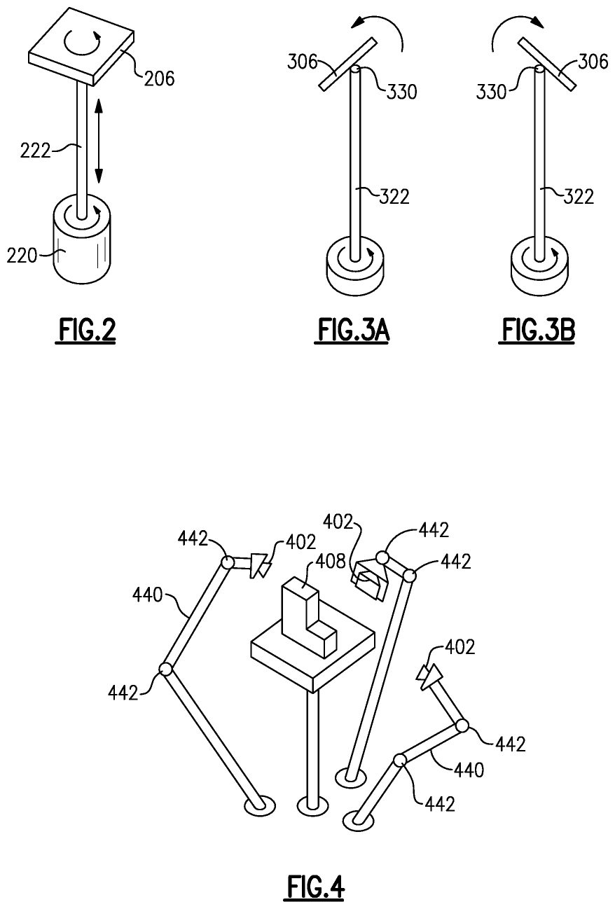

With continued reference to FIGS. 1 and 2, FIG. 3 schematically illustrates an exemplary shaft 322, and mount 306, where the mount 306 is connected to the shaft 330 via a controlled tilt joint 330. The controlled tilt joint 330 is a hinged joint that can be tilted by the controller 110, thereby allowing the mount 306 to be angled relative to the shaft 322. Tilting the mount 306, further increase the number of unique positions that the part can be maintained at, relative to the sensors 102, thereby further increasing the number of unique entries that can be acquired for the learning population from the limited set of samples. In one particular example, the tilt mount 330 of FIGS. 3A and 3B and the actuator 220 and shaft 222 of FIG. 2 can be combined in the sensor array 100 of FIG. 1.

With continued reference to FIGS. 1-3B, FIG. 4 schematically illustrates a set of sensors 402 mounted to articulating arms 440. Each of the articulating arms 440 includes multiple joints 442, and each of the joints 442 can be articulated in multiple directions according to any known or conventional articulating arm configuration. In some examples, the articulating arms 442 of FIG. 4 can be used in conjunction with the sensor 102 configuration in the sensor assembly 100 of FIG. 1. In alternative examples, the articulating arms 440 and sensors 442 can be used in place of the sensors 102 in the sensor assembly 100 of FIG. 1. In either example, the movement of the articulating arms 440 adjusts the position and orientation of the attached sensor 402 relative to the part 408 allowing for multiple distinct images or videos to be taken.

With reference to all of FIGS. 1-4, a user operating the sensor assembly 100 can identify if the part 408 is “good” or “bad” at the controller 110, prior to initiating the training data set generation, and each image or sound recording produced by the sensors 102, 402, will be tagged as being a sensor output of a “good” or “bad” part. When multiple parts 108, 408 are provided to generate the data set, and/or a sample part can be damaged to reflect an expected “bad” part 108, 408, additional sensor outputs can be generated and stored to the learning population. In this way, the neural network can be easily provided with thousands of sensor outputs corresponding to good and bad parts 108, 408 allowing the quality control inspection system to be fully trained from a substantially limited produce sample size. While “good” and “bad” tags are described herein, it is appreciated that any number of alternative tags can be used in place of, or in addition to, the “good” and “bad” tags and automatically applied to the sensor outputs by the controller 110.

With continued reference to FIGS. 1-4, FIG. 5 illustrates a method 500 for operating any of the above described sensor assembly 100 configurations to generate a sufficiently large number of data entries from a substantially limited sample size. In some examples, the sample size can be one, five or less, or ten or less, and provide an adequate neural network training set using the following method 500.

Initially the part, or the first part of the limited sample set, is placed on the mount in a “Place Part on Mount” step 510. In examples where the mount is a platform that is maintained in a constant position, or is moved slowly, the part can be maintained on the mount via gravity. In alternative examples, where the mount is moved at a faster rate, the mount is tilted, or where the mount is not a platform, the part can be affixed to the mount via an adhesive, a fastener such as a bolt, or any similar mounting structure. As part of the placement process, the user enters any tags corresponding to the part that is being captured into the controller via a user interface. By way of example, the tags can include good, bad, damaged, part numbers, part types, or any other classification of the part that is generating the data set

Once the part has been positioned on the mount, and the appropriate tags have been entered into the controller by the user, the method 500 captures an initial set of sensor outputs in a “Capture Sensor Output” step 520. The initial sensor outputs are saved to a first training data set at the controller, with the corresponding tags applied to each output, whether that output is an image file, an audio file, a video file or any other type of file. When one or more of the sensor outputs includes an audio file, the audio file is converted to a spectrograph (i.e., a visual representation of the sound) and is tagged as an audio sample. When one or more of the sensor outputs includes a video file, the video file is chopped into multiple static images.

Once the initial sensor outputs are captured, the controller manipulates at least one of a relative position and orientation between the sensors and the part in a “Manipulate Relative Positions” step 530 and the environment between the sensors and the part in a “Manipulate Environment” step 535. In some examples, both of the steps 530, 535 can occur simultaneously.

During the manipulate relative positions step 530, one or more of the sensors have their position and/or orientation relative to the part changed via any combination of the structures described above. In some examples, the part and the sensor can be repositioned or reoriented, and in other examples only one of the sensor and the part is repositioned or reoriented.

During the manipulate environment step 535, the controller is configured to adjust the lighting of the part to simulate various expected plant floor lighting conditions. By way of example, if a quality inspection location is exposed to intense sunlight during sunrise or sunset, and medium intensity sunlight for a remainder of the day, the environmental manipulation can include adjusting the lighting to match the intensity and angle of the sunrise/sunset light and to match the intensity and angle for a remainder of the day. In another example, if the inspection site is exposed to a pulsing light from nearby machines, the light source can be pulsed at a similar or the same pulse rate and intensity to match the expected environment. In yet another example, when the part is exposed to various colors or brightnesses of the light at the inspection site, the lighting can be manipulated to match the exposure.

In addition to the lighting manipulation, an environmental manipulator alters the environment between one or more of the sensors and the part. The environmental alteration can include creating an air current using a fan, creating fog and/or smoke effects using a fog or smoke generator, altering a temperature of the ambient environment, or any similar environmental manipulation. As with the lighting, the environmental alteration can be configured to simulate the expected operating conditions of the inspection system.

In examples where the expected ambient conditions of the inspection site are unknown, or may vary substantially, the environmental manipulation of both the lighting system and the environment manipulator can cover a wide range of possible environments,

Subsequent to, or simultaneous with, the environmental and positional manipulations, the method 100 captures the sensor outputs as an additional training data set in a “Capture Sensor Output” step 540. In some examples, such as those where one or more of the sensors are audio or video sensors, the manipulation steps 530, 535 and the capture sensor output steps 540 can occur simultaneously allowing for rapid generation of substantial numbers entries in the training set.

Once the manipulation steps 530, 535 and the capture sensor output steps 540 have been iterated sufficiently to generate a full neural network training set, all of the captured sensor outputs from the capture steps 520, 540 are combined, tagged with each tag provided to the controller for the part, and stored in a neural network training set in a “Store Captured Outputs as Training Data Set” step 550.

In systems where the user has been provided with multiple samples, or where the user is authorized to damage or otherwise alter the provided sample, the method 500 is reiterated for each sample provided and/or for each alteration to the provided sample(s). The resulting training data sets are combined to generate a multiplicatively larger training set.

In some examples, the data set output by the method 500 can be augmented using any conventional learning population augmentation processing including vertical or horizontal image flipping and image rotation, hue-saturation-brightness (HSB) changes, tilting-tipping, cropping, stretching, shrinking, aspect ratio changes, zooming in/out.

With continued reference to FIGS. 1-5, FIG. 6 illustrates an alternate example sensing apparatus 600. The sensing apparatus 600 includes a body 6001 with multiple outward facing sensors 602. The outward facing sensors 602 can be any type of sensor previously described with regards to the sensors 102 of FIG. 1, and can be maintained in a fixed position relative to the body 601 or manipulated about the body 601. In one example the body is supported by a shaft 630, and the body 601 can be further manipulated by rotation of the shaft 630 or axial linear manipulation of the shaft 630. In an alternative example, the shaft 630 can be replaced with an articulating arm, allowing for the body 601 to be manipulated.

To generate a sample size of an interior of a part, the body 601 is inserted into a cavity 609 within a part 608, and the sensors 602 capture sensor outputs of the interior of the part 608 due to their outward facing nature. In addition to the outward facing sensors 602, the body 601 can support one or more interior environmental manipulators 612.

In yet a further example, the pedestals 206, 306 of FIGS. 2 and 3 can be modified to allow for a body 600 to be disposed within an internal portion of the part 608, while at the same time supporting the part 608 for use within the sensing apparatus 100 of FIG. 1. In such an example, the body 600 is a part of the sensing apparatus 100, and provides sensor outputs to the controller 110.

Whether incorporated into the sensing apparatus 100 of FIG. 1, or utilized as a stand-alone sensing apparatus 600, the example of FIG. 6 is operated to generate multiple tagged images in the same manner, and to the same effect, as the sensing apparatus 100 of FIG. 1.

While described above with regards to a training data set for a neural network based quality inspection system, one of skill in the art will appreciate that the sensor apparatus and the method described herein are equally applicable to generating any neural network training data set and are not limited in application to quality control systems specifically, or inspection systems generally.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A method for generating a training data set for machine learning comprising:
disposing a first sample component in or about a sensing apparatus, the sensing apparatus including a plurality of sensors, each sensor in the plurality of sensors being disposed at a unique position and angle relative to the first sample component;
capturing a first sensor output of each sensor, thereby generating a first training data set including a first plurality of sensor outputs;
manipulating at least one of the first sample component and an environment within the sensing apparatus, and capturing an additional sensor output of each sensor, thereby generating an additional training data set including an additional plurality of sensor outputs;
reiterating the step of manipulating the at least one of the first sample component and the environment within the sensing apparatus and capturing the additional sensor output of each sensor, thereby generating an additional training data set including an additional plurality of sensor outputs; and
merging each of the sensor outputs in the first training data set and each additional training data set, thereby generating a full machine learning training set.

2. The method of claim 1, wherein at least a portion of the plurality of sensors are image sensors, and at least a portion of the first plurality of sensor outputs and a portion of each additional plurality of sensor outputs are one of images or movies.

3. The method of claim 2, wherein each of the sensors in the plurality of sensors is an image sensor, and wherein each of the sensor outputs in the first plurality of sensor outputs and in each additional plurality of sensor outputs are one of images or movies.

4. The method of claim 1, wherein manipulating at least one of the first sample component and the environment within the sensing apparatus comprises changing an orientation of the first sample relative to the sensing apparatus.

5. The method of claim 4, wherein changing the orientation comprises moving at least one of the sensors in the plurality of sensors relative to the first sample.

6. The method of claim 4, wherein changing the orientation comprises at least one of rotating the first sample about an axis by rotating a mount on which the sample is disposed and tilting the first sample by tilting the mount on which the sample is disposed.

7. The method of claim 1, wherein manipulating at least one of the first sample component and the environment within the sensing apparatus comprises adjusting a lighting within the sample apparatus.

8. The method of claim 7, wherein adjusting the lighting comprises at least one of dimming a light, increasing a brightness of the light, pulsing laser lights, adjusting light patterns, altering a color of the light and pulsing the light.

9. The method of claim 1, wherein manipulating at least one of the first sample component and the environment within the sensing apparatus comprises generating an atmospheric obstruction between at least one of the sensors in the plurality of sensors and the first sample.

10. The method of claim 9, wherein the manipulation of the at least one of the first sample component and the environment within the sensing apparatus is configured to simulate an ambient condition of a factory for producing the component.

11. The method of claim 1, further comprising reiterating the steps for at least one additional sample beyond the first sample.

12. The method of claim 1, wherein at least a portion of the plurality of sensors are audio sensors, and at least a portion of the first plurality of sensor outputs and a portion of each additional plurality of sensor outputs are sound files.

13. The method of claim 1, further comprising tagging each sensor output in the full machine learning set as a good component when the first sample is a good sample, and tagging each sensor output in the full machine learning set as a bad component when the first sample is a bad sample.

14. A sensing apparatus comprising:
a mount configured support a part;
a plurality of sensors supported about the mount, each sensor being oriented relative to the mount in distinct orientations from each other sensor in the plurality of sensors; and
a computerized controller communicatively coupled to each of the sensors in the plurality of sensors, the computerized controller including a database configured to store outputs of the sensors in the plurality of sensors according to a pre-determined sampling rate.

15. The sensing apparatus of claim 14, wherein the plurality of sensors includes at least two distinct image sensors.

16. The sensing apparatus of claim 14, wherein the plurality of sensors includes at least one audio sensor.

17. The sensing apparatus of claim 14, further comprising at least one adjustable light source connected to the computerized controller, and wherein the computerized controller includes instructions configured to cause the computerized controller to adjust the at least one adjustable light source to simulate a factory condition.

18. The sensing apparatus of claim 14, further comprising at least one environmental effect inducer configured to induce a desired ambient atmosphere at the mount.

19. The sensing apparatus of claim 18, wherein the at least one environmental effect inducer includes at least one of a fan, white noise generator, a smoke machine and a fog machine.

20. The sensing apparatus of claim 14, wherein the computerized controller further includes a graphical user interface configured to cause the sensing apparatus to perform the steps of:
capturing a first sensor output of each sensor in the plurality of sensors, thereby generating a first training data set including a first plurality of sensor outputs;
manipulating at least one of the mount and an environment within the sensing apparatus, and capturing an additional sensor output of each sensor in the plurality of sensors, thereby generating an additional training data set including an additional plurality of sensor outputs;
reiterating the step of manipulating the at least one of the mount and the environment within the sensing apparatus and capturing the additional sensor output of each sensor, thereby generating an additional training data set including an additional plurality of sensor outputs; and
merging each of the sensor outputs in the first training data set and each additional training data set, thereby generating a full labeled machine learning training set.
